(19) United States
(12) Patent Application Publication
(10) Pub. No.: US 2019/0299513 A1
(43) Pub. Date: Oct. 3, 2019

(54) Variable Land Extrusion Assembly

(71) Applicant: Superior Essex International LP, Atlanta, GA (US)

(72) Inventors: Wayne Patrick Cheatle, Hickory, NC (US); Christopher W. McNutt, Woodstock, GA (US)

(21) Appl. No.: 16/445,791

(22) Filed: Jun. 19, 2019

Related U.S. Application Data
(62) Division of application No. 15/641,461, filed on Jul. 5, 2017.

(51) Int. Cl. B29C 48/30; B29C 48/325

(52) U.S. Cl. CPC B29C 48/30; B29K 2105/0067; B29C 48/325

(57) ABSTRACT

An extrusion assembly may include an extrusion die and an extrusion tip at least partially positioned within the die. The extrusion tip may include a base portion having a tapered end and an opening positioned approximately at an apex of the tapered end. An insert may be adjustably positioned within the base portion and configured to extend through the opening to form a land. A length of the land may be variable as the position of the insert within the base portion is adjusted. Additionally, a length of an end portion of the extrusion die may be adjusted.

### CROSS-REFERENCE TO RELATED APPLICATION

This application is a division of co-pending U.S. patent application Ser. No. 15/641,461, filed Jul. 5, 2017 and entitled “Variable Land Extrusion Assembly,” which is incorporated by reference herein in its entirety.

### TECHNICAL FIELD

Embodiments of the disclosure relate generally to extrusion assemblies and, more particularly, to extrusion assemblies that include variable lands.

### BACKGROUND

Extrusion is utilized in a wide variety of different applications in order to create objects having a desired cross-sectional profile. For example, in wire and cable technology, extrusion is utilized to form conductor insulation, jacket layers, buffer tubes, or similar components. In a typical extrusion process for a cable component, a stock polymeric or other material is heated and passed through an extrusion die. The material typically flows between an extrusion tip and an extrusion die in order to form a desired extruded profile.

A wide variety of parameters can affect an extrusion profile and/or extrusion results. For example, changes to an extrusion die exit hole diameter and/or land length can affect the extrusion draw down ratio, balance, molecular alignment die swell, tip and die drool, extrusion shape, torque, and/or back pressure. With conventional extrusion apparatus, optimizing or adjusting tip and die sizes requires the disassembling and reassembly of an extrusion crosshead each time a change is made. As a result, a significant amount of effort may be expended on extrusion optimization, for example, when new designs are implemented or when new materials are tested. Additionally, with conventional extrusion apparatus, a wide variety of different extrusion tips and dies must be stored and maintained in order to facilitate various tooling options. Accordingly, there is an opportunity for improved extrusion assemblies.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIG. 1A is a perspective view of an example extrusion tip insert, according to an illustrative embodiment of the disclosure.

FIG. 1B is a perspective view of an example body portion of an extrusion tip, according to an illustrative embodiment of the disclosure.

FIG. 1C is a perspective view of an example extrusion die, according to an illustrative embodiment of the disclosure.

FIG. 2A is a side view of an example extrusion tip, according to an illustrative embodiment of the disclosure.

FIG. 2B is a cross-sectional side view of the example extrusion tip of FIG. 2A, according to an illustrative embodiment of the disclosure.

FIG. 3A is a side view of an example extrusion die, according to an illustrative embodiment of the disclosure.

FIG. 3B is a cross-sectional side view of the example extrusion die of FIG. 3A, according to an illustrative embodiment of the disclosure.

FIGS. 4A-4E are side views of example extrusion tip insert and extrusion die face plate combinations, according to illustrative embodiments of the disclosure.

FIG. 5 is a side view of an example extrusion tip having interchangeable end portions, according to an illustrative embodiment of the disclosure.

### DETAILED DESCRIPTION

Various embodiments of the present disclosure are directed to extrusion assemblies and/or extrusion components that include one or more adjustable or variable features. For purposes of this disclosure, the term extrusion assembly may be utilized to refer to suitable extrusion crossheads and/or other assemblies that facilitate die extrusion, as well as various subcomponents of an overall extrusion device or assembly (e.g., an extrusion crosshead, etc.), such as extrusion dies and/or extrusion tips. A wide variety of different types of extrusion assemblies may be formed to include variable features. For example, an extrusion tip may be formed with a variable length land. As another example, an extrusion die may include one or more removable face plates that permit variation of the die length. The incorporation of variable features into extrusion tips, dies, and/or other assemblies may simplify the modification of extrusion parameters, improve development and operating efficiency, and/or reduce equipment and tooling cost.

In various embodiments, an extrusion tip having a variable land may be provided. The extrusion tip may include a base portion and an insert adjustable positioned within the base portion. The base portion may include an opening positioned at one end. For example, the base may include a tapered end with an opening positioned approximately at an apex of the tapered end. Additionally, the insert may be configured to extend through the opening in order to form a land. The length of the land may be varied as the position of the insert within the base portion is adjusted. A wide variety of suitable methods and/or techniques may be utilized as desired to adjust the position of the insert within the base portion. For example, in certain embodiments, the insert and the base portion may include respective threading that allows the position of the insert to be modified within the base portion. As another example, the insert may be configured to telescopically extend from the base portion, and the insert may be maintained at a desired position via one or more suitable fastening components (e.g., pins, etc.).

In other embodiments, an extrusion die having a variable length may be provided. The extrusion die may include a body portion with an opening positioned at one end of the body portion. The die may be configured to permit a suitable extrusion tip to be positioned at least partially within the die such that the tip is aligned with the die opening. For example, a variable land extrusion tip may be aligned with the opening of the die body portion such that the tip land extends through the opening as it is lengthened. Additionally, one or more suitable face plates may be removably attached to the body portion. Each of the face plates may include a channel that may be aligned with the die opening, thereby facilitating the lengthening of the extrusion die. Each face plate may have any suitable thickness and/or other dimensions, thereby permitting a wide variety of different changes or adjustments to the die length and/or cross-section of a die opening. Additionally, a wide variety of suitable methods and/or techniques may be utilized to removably attach the face plates to a face of the die. For example, one or more bolts, screws, pins, clips, prongs, or other suitable attachment components may be utilized to removably attach the face plates to the die.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

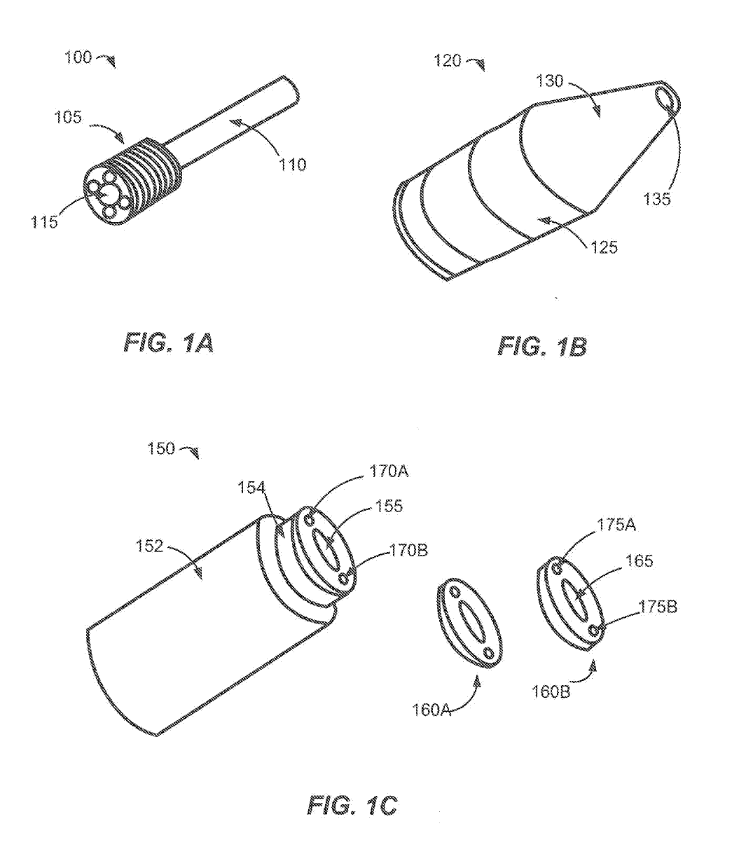

A few example components that may be incorporated into an extrusion assembly are illustrated in FIGS. 1A-C. In particular, FIG. 1A illustrates a perspective view of an example extrusion tip insert 100 that may be incorporated into an extrusion tip. FIG. 1B illustrates a perspective view of an example base portion 120 of an extrusion tip. In certain embodiments, the tip insert 100 and the base portion 120 may be combined in order to form an extrusion tip having a variable land (generally referred to as extrusion tip 120). FIG. 1C illustrates a perspective view of an example extrusion die 150 having a variable length that may be utilized in conjunction with an extrusion tip, such as extrusion tip 120. Each of these components are discussed in greater detail below.

As desired, an extrusion tip and extrusion die, such as the example tip 120 and die 150 illustrated in FIGS. 1A-C, may be incorporated into a wide variety of suitable extrusion crossheads and/or other suitable extrusion devices. In operation, the extrusion tip 120 may be positioned at least partially within the extrusion die 150. When a suitable material, such as a polymeric material is extruded, the material may flow over the tip 120 and within the die 150. In other words, the material may flow between the tip 120 and the die 150. An extrusion profile and/or a wide variety of parameters associated with the extruded material may be adjusted or altered by varying a land of the extrusion tip 120, a length of the die 150, and/or an opening or exit hole diameter of the die 150.

Turning first to FIG. 1A, the extrusion tip insert 100 may include an attachment portion 105 and a land portion 110 extending from the attachment portion 105. The attachment portion 105, which may also be referred to as an adjustment portion, may facilitate adjustable attachment of the tip insert 100 to a base portion 120 of an extrusion tip. The land portion 110 or land section may be configured to at least partially extend through the base portion 120 of the extrusion tip in order to form a land. As a position of the tip insert 100 is adjusted within the base portion 120, the land portion 110 may either be completely positioned within the base portion 120 or extend any desired length beyond the base portion 120. In this regard, the land length of the extrusion tip may be varied.

In certain embodiments, the attachment portion 105 and the land portion 110 may be formed as a single component 105. In other embodiments, the attachment portion 105 and the land portion 110 may be formed as separate components 105 that are joined together via any suitable methods and/or techniques, such a welding, one or more physical attachment apparatus (e.g., pins, screws, bolts, etc.), respective threadings that correspond to one another, etc. Additionally, in certain embodiments, the tip insert 100 (and/or its various components) may be formed as a relatively solid insert. In other embodiments, one or more channels, such as channel 115, may be formed through the tip insert 100 (and/or its various components). In operation, transmission media (e.g., optical fibers, conductors, etc.), a cable core, or other suitable structure may be passed through the one or more channels during an extrusion process. In this regard, insulation (e.g., cable conductor insulation, a jacket layer, etc.), a tube (e.g., a buffer tube, a microtube, etc.), a buffer layer (e.g., a tight buffer layer, etc.), or other desired structure may be extruded around cable components that are passed through the tip insert 100.

As desired in various embodiments, the tip insert 100 and/or its various components (e.g., the attachment portion 105, the land portion 110, etc.) may be formed with any suitable dimensions. For example, the tip insert 100 and/or various components of the tip portion 100 may be formed with any suitable longitudinal length, diameter, cross-sectional area, cross-sectional shape, and/or other dimensions. As shown in FIG. 1A, each component of the tip insert 100 may be formed with an approximately circular cross-sectional shape. Such a shape may facilitate the extrusion of material with an approximately circular inner circumference or shape. In other embodiments, one or more components of the tip insert 100 may be formed with other desired cross-sectional shapes, such as elliptical, rectangular, approximately rectangular (e.g., rectangular with rounded corners, etc.), square, approximately square, or other shapes. Additionally, in certain embodiments, the attachment portion 105 and the land portion 110 may be formed with similar cross-sectional shapes. In other embodiments, the attachment portion 105 and the land portion 110 may be formed with different cross-sectional shapes.

The components of the tip insert 100 may also be formed with any suitable respective diameter or cross-sectional area. As shown, the attachment portion 105 may have a diameter that is larger than a diameter of the land portion 110. Such as arrangement may facilitate attachment of the tip insert 100 to a tip base portion 120 via the attachment portion 105 while permitting the land portion 110 to extend beyond the base portion 120. In other embodiments, the attachment portion 105 may have a diameter that is approximately equal to or smaller than the diameter of the land portion 110. Additionally, although diameters are discussed herein, any suitable cross-sectional areas may be utilized in the event that one or more components of the tip insert 100 have non-circular cross-sectional shapes.

In the event that the land portion 110 of the tip insert 100 is extended beyond the base portion 120 of an extrusion tip, the extending region of the land portion 110 may form a land for extrusion. Accordingly, the dimensions (e.g., cross-sectional shape, diameter, cross-sectional area, etc.) of the extending region of the land portion 110 may be the dimensions of the extrusion land and may impact the extrusion parameters and/or profile of extruded material. In certain embodiments, the cross-sectional shape, diameter, and/or other desired dimensions of the land portion 110 may be relatively constant along a longitudinal length of the land portion 110. In other embodiments, one or more dimensions of the land portion 110 may be varied along a longitudinal length. For example, the land portion 110 may include a tapered end.

The tip insert 100 and/or its various components may be formed from any suitable materials and/or combinations of materials. For example, the tip insert 100 may be formed from one or more metals, steel, hardened steel, other metallic alloys, one or more superalloys (e.g., nickel-chromium alloys, etc.), tungsten, tungsten carbide, diamond, and/or other suitable materials. As desired in various embodiments, materials utilized to form tip insert components may be based at least in part on the properties of materials to be extruded. For example, a tip insert 100 formed from hardened steel may be utilized to extrude polymeric materials with relatively low melt temperatures while a tip insert 100 formed from more robust materials may be utilized to extrude polymeric materials with relatively higher melt temperatures. Additionally, in certain embodiments, the attachment portion 105 and the land portion 110 may be formed from the same material(s). In other embodiments, the attachment portion 105 and the land portion 110 may be formed from different materials.

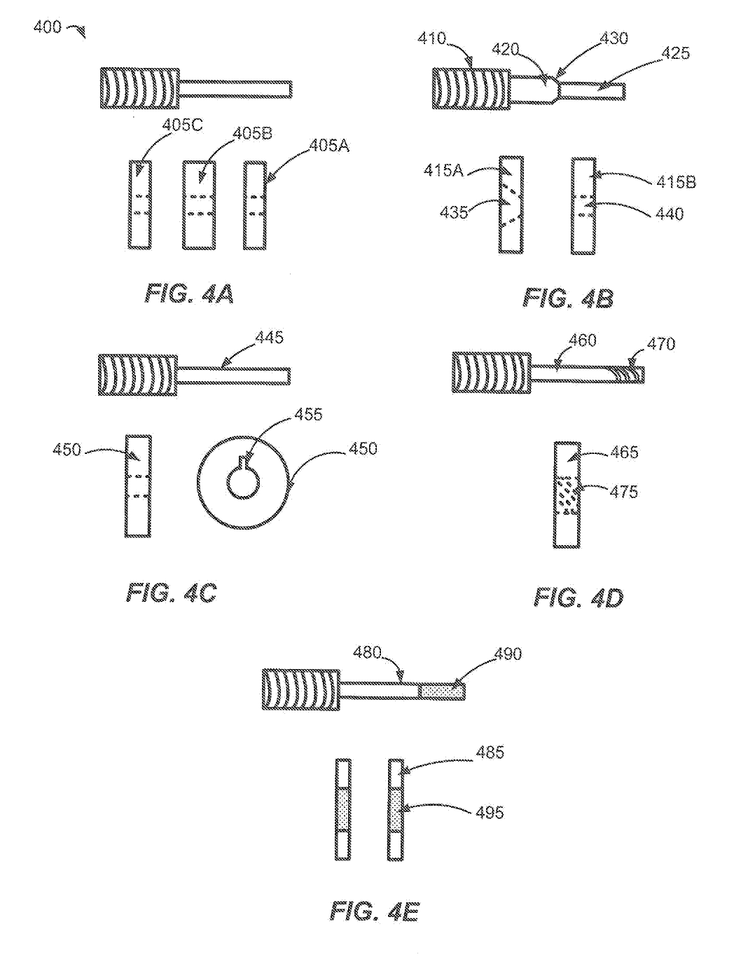

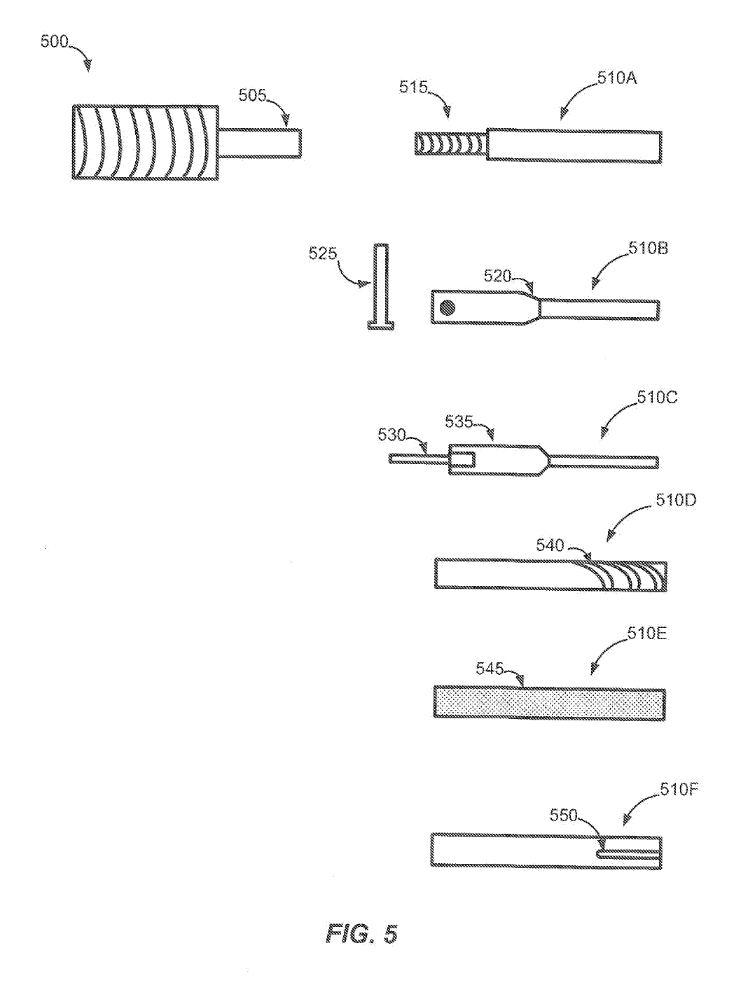

A wide variety of other suitable tip inserts may be utilized as desired in various embodiments, and the tip insert 100 of FIG. 1A is provided by way of non-limiting example only. A few other example tip inserts are discussed in greater detail below with reference to FIGS. 4A-5. Each of the tip inserts discussed with reference to FIGS. 4A-5, as well as any other suitable tip insert, may be positioned within a base portion of an extrusion tip in a similar manner as the tip insert 100 of FIG. 1A. Additionally, in certain embodiments, a plurality of interchangeable tip inserts may be utilized in conjunction with an extrusion tip. For example, various tip inserts may be interchanged in order to vary the diameter of an extruded component. In other embodiments, a tip insert may be formed with a plurality of interchangeable land portions or other suitable end portions.

FIG. 1B illustrates a perspective view of an example base portion 120 of an extrusion tip. As set forth above, a tip insert, such as the tip insert 100 of FIG. 1A, may be adjustably positioned within the base portion 120 such that a land length of the extrusion tip may be varied. The extrusion tip base portion 120 may include a body portion 125 and a flow portion 130. The body portion 125, which may also be referred to an attachment or adjustment portion, may provide overall support for the base portion 120 and/or facilitate adjustable attachment of the base portion 120 and the tip insert 100. The body portion 125 may include a cavity in which the tip insert 100 may at least partially be positioned. Additionally, the body portion 125 may include one or more features, such as threading formed on a surface of the cavity, that facilitates adjustable attachment between the tip insert 100 and the base portion 120.

The flow portion 130 may extend from one end of the body portion 125, and the flow portion 130 may be configured to be positioned in proximity to the opening of an extrusion die, such as the die 150 illustrated in FIG. 1C. In operation, extruded material may flow across the flow portion 130 prior to exiting the die 150. In certain embodiments, the flow portion 130 may include a tapered end. In other words, the flow portion 130 may include a first diameter or cross-sectional area at an end positioned proximate to or extending from the body portion 125 and a second diameter or cross-sectional area at a distal end of the flow portion 130. The second diameter or cross-sectional area may be smaller than the first diameter or cross-sectional area. In other words, the flow portion 130 may narrow along a direction at which an extruded material flows. A tapered end may be formed with a wide variety of dimensions as desired in various embodiments. For example, the tapered end may be formed with an approximate cone shape (e.g., a cone shape that ends prior to coming to a single point, etc.). Additionally, a tapered end may taper at a wide variety of desired rates or angles. In certain embodiments, a rate or degree of tapering may be based at least in part upon the dimensions of an extrusion die 150 utilized in conjunction with the extrusion tip 120.

Additionally, an opening 135 may be formed at an end of the flow portion 130 that is distal to the body portion 125. For example, the opening 135 may be formed at an apex of a tapered end or approximately cone shaped end. When the tip insert 100 is positioned within the base portion 120, the land portion 110 of the tip insert 100 may be configured to extend through the opening 135 in order to form a land. In the event that one or more channels 115 are formed through the tip insert 100, any cable components (e.g., transmission media, etc.) that pass through the one or more channels 115 may also pass through the opening 135. For example, a channel 115 passing through the tip insert 100 may be concentrically aligned with the opening 135. The opening 135 may have any suitable diameter or cross-sectional area as desired in various embodiments. In certain embodiments, the size and/or dimensions of the opening 135 may correspond to those of the land portion 110.

As desired in various embodiments, the base portion 120 and/or its various components (e.g., the body portion 125, the flow portion 135, etc.) may be formed with any suitable dimensions. For example, the base portion 120 and/or various components of the base portion 120 may be formed with any suitable longitudinal length, diameter, cross-sectional area, cross-sectional shape, and/or other dimensions. As shown in FIG. 1A, each component of the tip insert 100 may be formed such that it has an approximately circular cross-sectional shape at any given point along a longitudinal direction. Such a shape may facilitate the extrusion of material with an approximately circular inner circumference or shape. In other embodiments, one or more components of the base portion 120 may be formed with other desired cross-sectional shapes, such as elliptical, rectangular, approximately rectangular (e.g., rectangular with rounded corners, etc.), square, approximately square, or other shapes. Additionally, in certain embodiments, the body portion 125 and the flow portion 130 may be formed with similar cross-sectional shapes. In other embodiments, the body portion 125 and the flow portion 130 may be formed with different cross-sectional shapes.

The components of the base portion 120 may also be formed with any suitable respective diameters (e.g., inner diameter, outer diameter, etc.) or other suitable cross-sectional dimensions at any given point along a longitudinal direction. For example, the components of the base portion 125 may have inner dimensions that facilitate at least partial positioning of the tip insert within the base portion 120. As another example, the components of the base portion 125 may have outer dimensions that facilitate at least partial positioning of the extrusion tip 120 within an extrusion die 150 while allowing material to be extruded between the extrusion tip 120 and die 150. Additionally, although diameters are discussed herein, any suitable cross-sectional dimensions may be utilized in the event that one or more components of the base portion 120 have non-circular cross-sectional shapes.

The base portion 120 and/or its various components may be formed from any suitable materials and/or combinations of materials. For example, the base portion 120 may be formed from any of the materials discussed above with reference to the tip insert 100. As desired in various embodiments, materials utilized to form base portion components may be based at least in part on the properties of materials to be extruded. Additionally, in certain embodiments, the body portion 125 and the flow portion 130 may be formed from the same material(s). In other embodiments, the body portion 125 and the flow portion 130 may be formed from different materials.

In certain embodiments, the tip insert 100 may be adjustable connected to the base portion 120. For example, the tip insert 100 may be positioned at least partially inside the base portion 120. Additionally, the position of the tip insert 100 within the base portion 120 may be adjusted or varied as desired. For example, the position of the tip insert 100 may be adjusted along a longitudinal direction. As the position of the tip insert 100 is adjusted, the tip insert 100 may extend through the opening 130 in order to form an extrusion tip land. For example, the tip insert 100 may telescopically extend through the opening 130. Additionally, the length of the land may be varied based at least in part upon the position of the tip insert 100. A wide variety of suitable land lengths may be formed as desired in various embodiments. For example, with the extrusion of a tube (e.g., a buffer tube, etc.) or other component, a land length may be varied between approximately zero times (e.g., the end of the land portion 110 is approximately aligned with or flush with the opening 135, etc.) and approximately 45 times the thickness of a finished tube or other component. In various embodiments, the tip insert position may be adjusted in order to form a land having a length of approximately 0, 1, 2, 3, 4, 5, 7, 8, 10, 12, 15, 20, 22, 25, 27, 30, 32, 35, 38, 40, 42, or 45 times a thickness of an extruded component, a length included in a range between any two of the above values, or a length included in a range bounded on either a minimum or maximum end by one of the above values.

A wide variety of suitable methods, techniques, and/or components may be utilized to adjustably connect the tip insert 100 and the base portion 120. For example, in certain embodiments, respective threadings may be formed on the tip insert 100 (e.g., on an outer surface of the attachment portion 105) and the base portion 120 (e.g., on an inner surface of the body portion 125. The respective threadings may facilitate movement or adjustment of the tip insert 100 within the base portion 120. For example, at least a portion of the body portion 125 may be rotated in order to adjust or change the position of the tip insert 100. In certain embodiments, the position of the tip insert 100 may be adjusted using a suitable wrench or other tool, such as a spanner wrench. For example, a spanner wrench may be used to rotate or twist a portion of the body portion 125. A wide variety of other suitable tools may be utilized as desired. In other embodiments, the body portion 125 may be rotated or twisted by hand.

In yet other embodiments, the tip insert 100 may be relatively free to slide or otherwise move along a longitudinal direction within the base portion 120. For example, the tip insert 100 may be relatively free to move within and telescopically extend from an opening 135 of the base portion 120. Additionally, any number of suitable components, devices, or attachment mechanisms may be utilized to maintain a desired position of the tip insert 100 and/or a desired land length for the extrusion tip. For example, one or more pins, bolts, screws, prongs, or other removable or adjustable attachment apparatus may be utilized to maintain a desired position of the tip insert 100.

During an extrusion operation, an extrusion tip 120 may be configured to operate in conjunction with a suitable extrusion die, such as the die 150 illustrated in FIG. 1C. The die 150 may be position over the tip 120 such that an extruded material flows between the tip and the die. The die 150 may include a body portion 152 and a flow portion 154. Additionally, in certain embodiments, the die 150 may include one or more removable face plates 160A, 160B that may be utilized to extend the length of the die 150. The body portion 152 may provide overall support for the die 150, and the body portion 152 may include a cavity in which the extrusion tip 120 may at least partially be positioned. As desired, the body portion 152 may include one or more features that facilitate attachment between the extrusion tip 120 and the die 150. In other embodiments, the extrusion tip 120 and the die 150 may be individually secured within an extrusion apparatus, such as an extrusion crosshead.

The flow portion 154 may extend from one end of the body portion 152, and the flow portion 154 may be configured to be positioned in proximity to the opening 135 of an extrusion tip 120. As desired, the flow portion 154 may have an internal dimensions that facilitate material extrusion. For example, the flow portion 154 may include an internal surface that is tapered or that narrows as it extends from the body portion 152. In the event that the flow portion 154 includes a tapered internal surface or cavity, a wide variety of suitable degrees of tapering may be utilized as desired. Additionally, an opening 155 may be formed at an end of the flow portion 154 that is distal to the body portion 152. For example, the opening 155 may be formed at an apex of a tapered end. The opening 155 may be aligned (e.g., concentrically aligned, etc.) with an opening 135 of the extrusion tip 120. In certain embodiments, the land portion 110 of the tip insert 100 may extend through the opening 155 as a land is lengthened. The opening 155 may have any suitable diameter or cross-sectional area as desired in various embodiments. In certain embodiments, the size and/or dimensions of the opening 155 may be based at least in part on those of the tip insert opening 135 and/or the land portion 110.

In certain embodiments, the flow portion 155 may be fixedly attached to the body portion 152 or combined with the body portion 152 to form a single continuous or integral component. In other embodiments, the flow portion 155 may be removably attached to the body portion 152 in a similar manner as the face plates 160A, 160B are removably attached to the remainder of the die 150. In this regard, various flow portions 130 having different extrusion profiles may be utilized in conjunction with an extrusion die 150.

With continued reference to FIG. 1C, in certain embodiments, one or more face plates 160A, 160B may be removably attached to a surface of the die 150. For example, one or more face plates 160A, 160B may be removably attached to the flow portion 154. Each of the face plates (individually referred to as face plate 160) may include a channel 165 that may be aligned with the opening 155 of the die 150. The selective attachment of face plates 160A, 160B may facilitate adjustments to a wide variety of die parameters, such as increases to the die length and/or modifications to the die exit diameter. In certain embodiments, as face plates 160A, 160B are added, a flow region of the die 150 may be increased. In other embodiments, one or more face plates 160A, 160B may facilitate adjustment to a die exit diameter. For example, channels within successive plates 160A, 160B may narrow or taper. As another example, face plates (and/or a flow portion 154) having different channel and/or opening diameters may be selectively utilized in order to modify a die exit hole diameter.

Any number of face plates 160A, 160B may be utilized in conjunction with a die 150 as desired in various embodiments. Each face plate 160 may also have any suitable thickness. For example, each face plate 160 may have a thickness of approximately 1.0, 1.5, 2.0, 2.0, 2.5, 3.0, 3.5, 4.0, 4.5, 5.0, 6.0, 7.0, 8.0, 9.0, 10.0, 12.0, 14.0, 15.0, 16.0, 18.0, or 20.0 mm, a thickness included in a range between any two of the above values, or a thickness included in a range bounded on either a minimum or a maximum end by one of the above values.

Additionally, in certain embodiments, each of the face plates may have a thickness that is approximately equal. In other embodiments, as illustrated in FIG. 1, at least two face plates may have different thicknesses. Indeed, any suitable combination of face plates with any respective thicknesses may be combined in order to achieve a desired die length and/or extrusion profile. A few additional face plate examples are discussed in greater detail below with reference to FIGS. 4A-4E. It will be appreciated that any suitable face plates may be utilized in conjunction with an extrusion die.

In certain embodiments, a die length may be adjusted such that it is aligned with or corresponds to a land length. For example, if a tip insert 100 is adjusted such that a land extends beyond the opening 155 of the die 150, then one or more suitable face plates 160A, 160B may be affixed to the die 150 such that the resulting die opening (e.g., the die opening formed from a combination of the flow portion 154 and face plates 160A, 160B, etc.) is approximately flush with the tip of the land portion 110. In other embodiments, the die length may be set or adjusted such that the die opening (as optionally modified by one or more face plates 160A, 160B) extends beyond the tip of the land portion 110. In yet other embodiments, the die length may be set or adjusted such that the land portion 110 extends beyond the die opening (as optionally modified by one or more face plates 160A, 160B).

A wide variety of suitable methods, techniques, and/or components may be utilized to removably attach one or more face plates 160A, 160B to a face of the die 150. For example, one or more suitable screws, pins, bolts, prongs, or other removable attachment apparatus may be utilized to affix the one or more face plates 160A, 160B. As shown in FIG. 1C, the flow portion 154 (or alternatively the body portion 152) may include a first set of one or more threaded channels or other openings 170A, 170B configured to receive respective attachment apparatus. Similar, each of the face plates 160 may include a second set of one or more threaded channels or other openings 175A, 175B configured to receive respective attachment apparatus. In operation, the respective sets of openings may be aligned with one another, and attachment apparatus (e.g., screws, etc.) may be utilized to removably affix one or more face plates 160A, 160B to a face of the die 150. In other embodiments, each face plate 160 may include one or more threaded portions that permit the face plate 160 to be twisted or screwed onto a face of the die 150 or to another face plate 160. A wide variety of other suitable attachment mechanisms may be utilized as desired.

As an alternative to affixing one or more face plates 160A, 160B to a die 150, in certain embodiments, a flow portion 154 may be formed as a telescoping flow portion 154. In other words, a length of the flow portion 154 may be adjusted or modified. Similarly, in other embodiments, one or more face plates may be formed as telescoping face plates. In yet other embodiments, a die 150 may be constructed with an adjustable insert that permits a length of the die 150 to be modified in a similar manner as that described above for the extrusion tip 120. Indeed, a wide variety of techniques may be utilized as desired to modify a die length.

As desired in various embodiments, the die 150 and/or its various components (e.g., the body portion 152, the flow portion 154, etc.) may be formed with any suitable dimensions. For example, the die 150 and/or various components of the die 150 may be formed with any suitable longitudinal length, diameter, cross-sectional area, cross-sectional shape, and/or other dimensions. As shown in FIG. 1C, each component of the die 150 may be formed such that it has an approximately circular cross-sectional shape at any given point along a longitudinal direction. Such a shape may facilitate the extrusion of material with an approximately circular inner circumference or shape. In other embodiments, one or more components of the die 150 may be formed with other desired cross-sectional shapes, such as elliptical, rectangular, approximately rectangular (e.g., rectangular with rounded corners, etc.), square, approximately square, or other shapes. Additionally, in certain embodiments, the body portion 152 and the flow portion 154 may be formed with similar cross-sectional shapes. In other embodiments, the body portion 152 and the flow portion 154 may be formed with different cross-sectional shapes. The components of the die 150 may also be formed with any suitable respective diameters (e.g., inner diameter, outer diameter, etc.) or other suitable cross-sectional dimensions at any given point along a longitudinal direction. For example, the components of the die 150 may have inner dimensions that facilitate at least partial positioning of the extrusion tip 120 within the die 150. Additionally, although diameters are discussed herein, any suitable cross-sectional dimensions may be utilized in the event that one or more components of the die 150 have non-circular cross-sectional shapes.

The die 150 and/or its various components may be formed from any suitable materials and/or combinations of materials. For example, the die 150 may be formed from any of the materials discussed above with reference to the tip insert 100. As desired in various embodiments, materials utilized to form die components may be based at least in part on the properties of materials to be extruded. Additionally, in certain embodiments, the die components (e.g., the body portion 152, the flow portion 154, one or more face plates 160A, 160B, etc.) may be formed from the same material(s). In other embodiments, two or more components of a die 150 may be formed from different materials.

An extrusion tip and extrusion die, such as the tip 120 and die 150 discussed above with reference to FIGS. 1A-C, may be utilized in a wide variety of suitable applications. For example, an extrusion tip 120 and die 150 may be incorporated into an extrusion crosshead or other device that is configured to extrude one or more cable components. Examples of suitable cable components that may be extruded included, but are not limited to, conductor insulation, inner cable jackets, outer cable jackets, optical fiber tight buffer layers, microtubes, buffer tubes, etc.

Additionally, as a result of incorporating one or more variable features, a wide variety of benefits may be provided by an extrusion tip 120 and/or die 150. For example, a land length, die length, and/or die exit hole diameter may be adjusted or modified without disassembling and reassembling an extrusion crosshead. As a result, a wide variety of adjustments may be made to extrusion parameters and/or an extrusion profile with greater efficiency than with conventional extrusion apparatus. For example, adjustments may be made to the draw down ratio, balance, molecular alignment, die swell, tip and die drool, extrusion shape, torque, back pressure, and/or any other suitable parameters. In certain embodiments, one or more variable features may improve the efficiency of cable trials and/or evaluation of new materials. The variable feature(s) may also improve the efficiency of equipment adjustments within a manufacturing environment. Additionally, an amount of die and tip tooling equipment maintained at a research or manufacturing facility, such as various tip and die combinations, may be reduced, thereby lowering equipment costs.

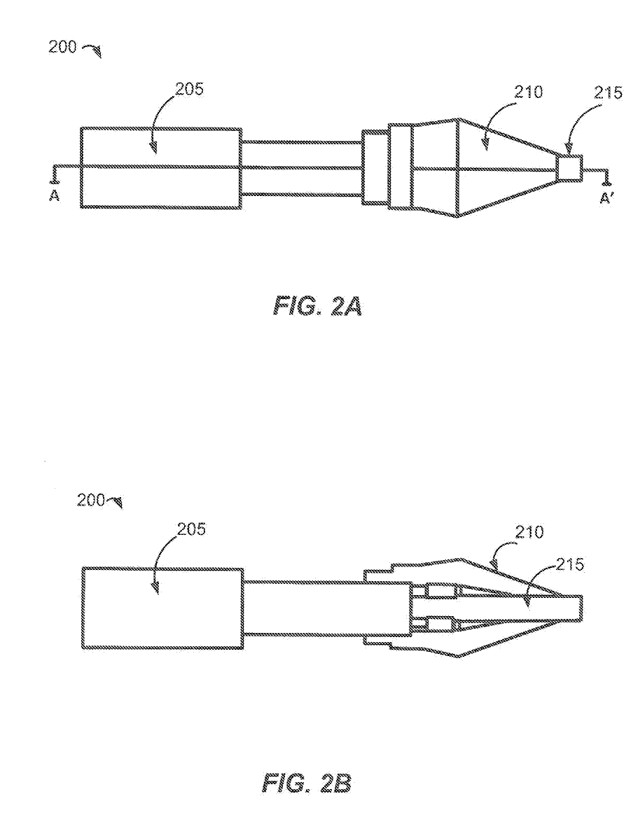

FIG. 2A illustrates a side view of an example extrusion tip 200, according to an illustrative embodiment of the disclosure. FIG. 2B is a cross-sectional side view of the example extrusion tip 200 of FIG. 2A taken along line A-A′. The extrusion tip 200 may include similar components as those discussed above for the extrusion tip 120 illustrated in FIGS. 1A and 1B. For example, the extrusion tip 200 may include a base portion 205 and a flow portion 210, such as a tapered flow portion. Additionally, a tip insert may be adjustably positioned within the base portion 205 such that a land portion 215 may selectively extend through an opening of the flow portion 210 to form a variable length land. FIG. 2A illustrates a situation in which the land portion 215 extends beyond the flow portion 210 in order to for a land. By contrast, FIG. 2B illustrates a situation in which an end of the land portion 215 is approximately flush with or aligned with an opening of the flow portion 210. As a result, the extrusion tip 200 does not have a land in the configuration of FIG. 2B. As set forth above, the position of the tip insert may be adjusted longitudinally within the base portion 205 in order to form a wide variety of different land lengths.

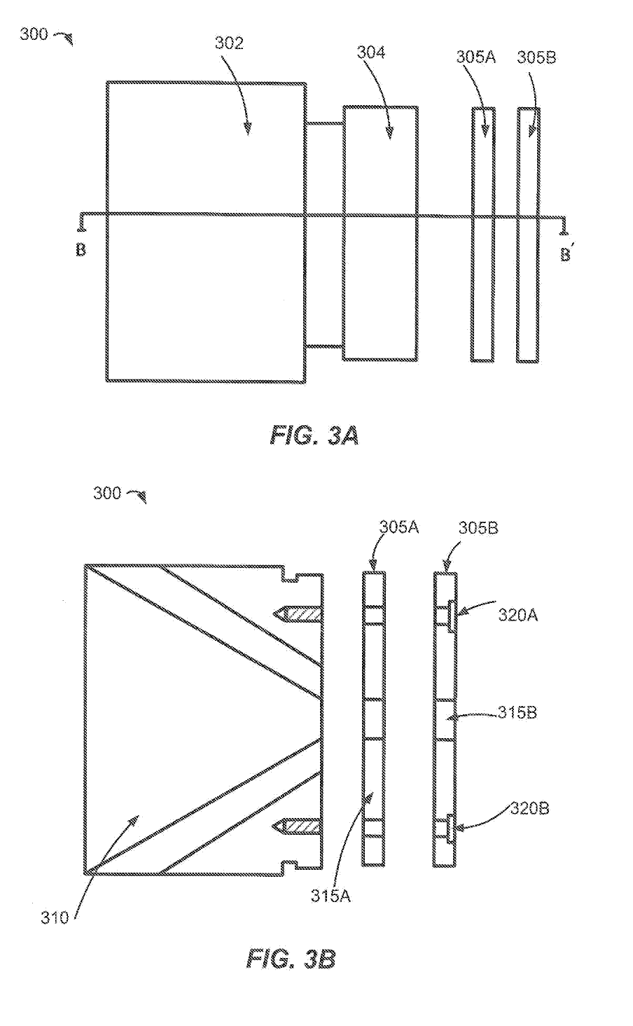

FIG. 3A illustrates a side view of an example extrusion die 300, according to an illustrative embodiment of the disclosure. FIG. 3B is a cross-sectional side view of the example extrusion die 300 of FIG. 3A taken along line B-B′. The extrusion die 300 may include similar components as those discussed above for the extrusion die 150 illustrated in FIG. 1C. For example, the die 300 may include a suitable body portion 302 and/or flow portion 304. Additionally, any number of suitable face plates 305A, 305B may be removably attached to a face of the die 300 in order to modify a wide variety of suitable die parameters, such as a die length and/or die exit diameter.

With reference to FIG. 3B, an extrusion tip 310 is illustrated as being at least partially positioned within the die 300. In operation, extruded material may flow between the extrusion tip 310 and the die 300. Additionally, in the event that a land extends from the extrusion tip 310 (e.g., a variable length land, etc.), the land may extend through a die exit hole or opening and optionally through a respective channel 315A, 315B formed through each of the face plates 305A, 305B. Additionally, one or more suitable attachment components, such as the illustrated bolts 320A, 320B may be utilized to removably affix the face plate(s) 305A, 305B to a face of the die 300 as discussed in greater detail above.

A wide variety of suitable extrusion tip inserts and/or extrusion die face plates may be utilized as desired in various embodiments of the disclosure. In certain embodiments, FIGS. 4A-4E are side views of example extrusion tip insert and extrusion die face plate combinations that may be utilized in various embodiments of the disclosure. FIG. 4A illustrates a first example tip insert 400 that may be utilized in conjunction with any number of suitable extrusion die face plates 405A-C. The tip insert 400 and the die face plates 405A-C may be similar to the tip insert 100 and face plates 106A, 106B illustrated in FIG. 1 and described in greater detail above. In certain embodiments, the tip insert 400 may include a land portion having a relatively constant diameter or cross-sectional area.

FIG. 4B illustrates another example tip insert 410 that may be utilized in conjunction with any number of suitable extrusion die face plates 415A, 415B. The tip insert 410 may include a land portion having a variable diameter, cross-sectional area, thickness, and/or other suitable dimensions. For example, as shown, a first section 420 of the land portion may have a first diameter while a second section 425 of the land portion may have a second diameter smaller than the first diameter. As a result of decreasing the diameter of the land portion, the tip insert 410 may be utilized in conjunction with the extrusion of cable components (e.g., buffer tubes, etc.) having a smaller inner diameter and/or other dimensions (e.g., dimensions that would be extruded with a land portion having the first diameter, etc.) without disassembling an extrusion crosshead. In certain embodiments, tip inserts may be interchanged within an extrusion tip to facilitate the extrusion of cable components having any desired inner diameters and/or other dimensions. In other embodiments, as discussed in greater detail below, land portions (or other sections of a single tip insert) may be interchanged.

As shown, the tip insert 410 may additionally include a tapered portion 430 that facilitates a decrease or other variation of the land portion diameter. The tapered portion 430 may include any suitable longitudinal length and/or degree or angle of taper as desired in various embodiments. The utilization of different tip inserts 410 having different tapered portions and/or degrees of taper may facilitate a wide variety of extrusion profiles. Additionally, in certain embodiments, one or more die face plates may include a channel having a taper (e.g., an angle and/or longitudinal length of tapering, etc.) that matches or otherwise corresponds to the tapered portion 430 of the tip insert 410. For example, as shown in FIG. 4B, a first face plate 415A may include a tapered channel 435 that corresponds to the tapered portion 430. One or more additional face plates 415B may then include respective channels 440 that correspond to the second diameter. In this regard, it the tip insert 410 is extended from an extrusion tip, appropriate face plates may be added to the die to accommodate a desired extrusion profile.

FIG. 4C illustrates another example tip insert 445 that may be utilized in conjunction with any number of suitable extrusion die face plates, such as face plate 450. The tip insert 445 may be similar to the tip insert 100 and illustrated in FIG. 1; however, the face plate 450 may include one or more notches 455 or other features that facilitate the modification of an extrusion profile. Both side and front views of the face plate 450 are illustrated, and a notch 455 is clearly visible in the front view. In certain embodiments, a cable component may be extruded to include one or more ridges, textured portions, or other features that are formed as a result of the one or more notches 455. In other embodiments, as discussed below with reference to FIG. 5, a tip insert 445 may also be formed with one or more ridges, channels, notches, and/or other features that facilitate the modification of an extrusion profile.

FIG. 4D illustrates another example tip insert 460 that may be utilized in conjunction with any number of suitable extrusion die face plates 465. At least one of the tip insert 460 and/or the face plate(s) 465 may include one or more spiral features, such as spiral grooves and/or ridges. As shown, one or more spiral features 470 may be formed on the tip insert 460, for example, approximately near the end of a land portion. Similarly, one or more spiral features 475 may be formed on the surface of a channel formed through the die face plate 465. During extrusion, the spiral features 470, 475 may assist in orienting an extruded polymer in a direction of the spiraling, thereby stretching the polymer and reducing subsequent shrinkage. Any number of spiral features 470, 475 and/or similar polymer orientation features may be utilized as desired, and the orientation features may include a wide variety of suitable dimensions.

FIG. 4E illustrates another example tip insert 480 that may be utilized in conjunction with any number of suitable extrusion die face plates 485. At least one of the tip insert 480 and/or the face plate(s) 485 may include a modified surface portion. As shown, at least a portion 490 of the tip insert land portion may include a modified surface. Similarly, an inner surface 495 of a respective channel formed through one or more face plates 485 may include a modified surface. A wide variety of suitable surface modifications may be utilized as desired in various embodiments. In certain embodiments, a surface may be modified or formed to include polytetrafluoroethylene (e.g., Teflon, etc.), silicon, or another suitable substance that reduces polymer shear stress during extrusion. In other embodiments, a surface may be modified to include a wide variety of suitable texturing or other features.

In certain embodiments, a plurality of tip inserts may be interchangeable within an extrusion tip. The tip inserts discussed above with reference to FIGS. 4A-4E are provided by way of non-limiting example only, and a wide variety of other suitable tip inserts may be utilized as desired. In other embodiments, a tip insert may include a plurality of interchangeable end portions (e.g., interchangeable land portions, interchangeable ends that attach to a remainder of a land portion, etc.). FIG. 5 is a side view of an example extrusion tip 500 having interchangeable end portions. The extrusion tip 500 may include a base portion 505 and a plurality of end portions 510A-F that may be interchangeably affixed or attached to the base portion 505. As shown, the base portion 505 may include an adjustment region and a first portion of a land portion while the interchangeable end portions 510A-F may each constitute a remainder of an a land portion. In other embodiments, each end portion 510A-F may be formed as a land portion that may be interchangeably attached to an adjustment portion.

Additionally, a wide variety of suitable end portions 510A-F may be utilized as desired in various embodiments. Further, a wide variety of suitable methods and/or techniques may be utilized to interchangeably attach an end portion (generally referred to as end portion 510) to the remainder of the tip insert 500. A few example end portions 510A-F and their corresponding features, as well as a few example attachment techniques, are described in greater detail below. It will be appreciated that any combination of end portion features and/or attachment techniques may be utilized as desired in a tip insert 500. A first end portion 510A may be formed with a relatively uniform diameter or cross-sectional area. In other words, when affixed to the base portion 505, the tip insert 500 may be similar to the tip insert 100 discussed above with reference to FIG. 1. Additionally, the end portion 510A may include a threaded region 515 that facilitates attachment of the end portion 510A to the base portion 505. For example, the threaded region 515 may interact with a corresponding threaded region of the base portion 505 to facilitate removable attachment of the end portion 510.

A second end portion 510B may have a variable diameter or cross-sectional area. For example, the second end portion 510B may include a tapered section or region 520 that facilitates a reduction in the diameter of a land portion. As discussed above, a reduced diameter may facilitate the extrusion of cable components having reduced inner diameters and/or other dimensions. Similarly, a third end portion 510C may also include a variable diameter. However, the second and third end portions 510B, 510C may be formed with at least one differing dimension. For example, a different angle of tapering, longitudinal length of the tapering region, resulting diameter following tapering, longitudinal length of smaller diameter regions, and/or a wide variety of other dimensions may be varied between different interchangeable end portions. Accordingly, end portions may be swapped out to achieve a wide variety of desired extrusion profiles.

With continued reference to the second end portion 510B, an alternative attachment mechanism is illustrated. As shown, one or more bolts, screws, pins, clips, prongs, or other suitable attachment components may be utilized to removably attach the second end portion 510B to the base portion 505. The third end portion 510C illustrates another alternative attachment mechanism. An insert portion 530, such as a suitable pin, may be configured to extend into the base portion 505, and one or more notches, prongs, or tabs 535 may pair with corresponding features of the base portion 505 to prevent or reduce the risk of the end portion 510C rotating and/or detaching from the base portion 505. A wide variety of other suitable attachment mechanisms may be utilized as desired in various embodiments.

A fourth end portion 510D may include one or more spiral features 540 that may facilitate orientation of an extruded polymer in a similar manner as that discussed above with reference to FIG. 4D. In certain embodiments, an orientation of the spiral features 540 may be opposite to that utilized to screw an end portion into a base portion, thereby reducing the chances that the end portion may detach during extrusion. A fifth end portion 510E (or at least a section thereof) may include a modified surface 545 that may facilitate reduction of shear stress during extrusion. Finally, a sixth end portion 510F may include one or more grooves, channels, or extensions 550 that facilitate the formation of one or more ridges, textured portions, or other features within an extruded component in a similar manner as that discussed above for the face plate 450 illustrated in FIG. 4C. A wide variety of other suitable end portions may be utilized as desired in various embodiments.

As desired in various embodiments, a wide variety of other components may be incorporated into an extrusion assembly and/or various components of an extrusion assembly. The extrusion assemblies and/or components discussed herein are provided by way of non-limiting example only. Embodiments of the disclosure contemplate a wide variety of other constructions. These constructions may include more or less components than the extrusion assemblies discussed herein. Additionally, certain components may have different dimensions and/or material constructions than the components discussed herein.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An extrusion assembly, comprising:
an extrusion die;
an extrusion tip at least partially positioned within the extrusion die such that extruded material is configured to flow between the extrusion tip and the extrusion die, the extrusion tip comprising:
a base portion comprising a tapered end and an opening positioned approximately at an apex of the tapered end; and
an insert adjustably positioned within the base portion and configured to extend through the opening to form a land,
wherein a length of the land is variable as the position of the insert within the base portion is adjusted; and
at least one face plate removably attached to the extrusion die, the at least one face plate comprising a channel aligned with the opening.

2. The extrusion assembly of claim 1, wherein the insert and the base portion comprise respective threadings that facilitate adjustment of the insert's position within the base portion.

3. The extrusion assembly of claim 1, wherein the insert comprises a tapered region that reduces a diameter of the insert.

4. The extrusion assembly of claim 1, wherein the insert is configured to telescopically extend through the opening.

5. The extrusion assembly of claim 1, wherein the insert further comprises a removable end portion.

6. The extrusion assembly of claim 1, wherein the opening comprises a first opening and the channel comprises a first channel, and further comprising:
a second channel extending through the insert, the second channel comprising a second opening concentrically aligned with the first opening.

7. The extrusion assembly of claim 1, wherein the tapered end comprises an approximate cone shape.

8. The extrusion assembly of claim 1, wherein the at least one face plate comprises a plurality of face plates, each of the plurality of face plates comprising a respective channel aligned with the opening.

9. The extrusion assembly of claim 8, wherein a first of the plurality of face plates comprises a first channel having a first diameter and a second of the plurality of face plates comprises a second channel having a second diameter different than that of the first diameter.

10. The extrusion assembly of claim 1, wherein the channel comprises a tapered channel.

11. An extrusion assembly, comprising:
an extrusion die comprising a tapered inner surface, a first opening positioned at an end of the tapered inner surface, and an adjustable die end portion that selectively extends away from the first opening and comprises a channel aligned with the first opening; and
an extrusion tip at least partially positioned within the extrusion die, the extrusion tip comprising:
a base portion comprising a tapered end and a second opening positioned approximately at an apex of the tapered end, wherein extruded material is configured to flow through a cavity between the tapered inner surface and the tapered end to the first opening, the cavity having fixed dimensions; and
an insert adjustably positioned within the base portion and configured to extend through the second opening to form a land,
wherein a length of the land is variable as the position of the insert within the base portion is adjusted.

12. The extrusion assembly of claim 11, wherein the insert and the base portion comprise respective threadings that facilitate adjustment of the insert's position within the base portion.

13. The extrusion assembly of claim 11, wherein the insert is configured to telescopically extend through the second opening.

14. The extrusion assembly of claim 11, wherein the insert further comprises a removable insert end portion.

15. The extrusion assembly of claim 11, wherein the channel comprises a first channel and further comprising a second channel extending through the insert, the second channel comprising a third opening concentrically aligned with the second opening.

16. The extrusion assembly of claim 11, wherein the adjustable die end portion comprises at least one face plate removably attached to the extrusion die, the channel extending through the at least one face plate.

17. The extrusion assembly of claim 16, wherein the at least one face plate comprises a plurality of face plates, the channel extending through each of the plurality of face plates.

18. The extrusion assembly of claim 11, wherein the at least one face place comprises a telescoping face plate.

19. The extrusion assembly of claim 11, wherein the channel comprises a tapered channel aligned with the first and second openings.

20. The extrusion assembly of claim 11, wherein the adjustable die end portion comprises a telescoping die end portion.
